(19) United States
(12) Patent Application Publication
(10) Pub. No.: US 2026/0358627 A1
(43) Pub. Date: Nov. 12, 2026

(54) HEAD-UP DISPLAY DEVICE

(71) Applicant: EYELIGHTS, LABEGE (FR)

(72) Inventors: Patrice NAGTEGAELE, ESCALQUENS (FR); Romain DUFLOT, CASTANET-TOLOSAN (FR); Quentin AILLOUD, VARENNES (FR)

(21) Appl. No.: 19/118,253

(22) PCT Filed: Oct. 5, 2023
(86) PCT No.: PCT/EP2023/077647

§ 371 Date: Apr. 3, 2025

(30) Foreign Application Priority Data
Oct. 7, 2022 (FR) FR2210293

(51) Int. Cl. G02B 27/01; B60K 35/22; B60K 35/233; B60K 35/29

(52) U.S. Cl. CPC G02B 27/0101; B60K 35/22; B60K 35/233; B60K 35/29; G02B 27/0149; G02B 27/0179; B60K 2360/1868; G02B 2027/013; G02B 2027/0154; G02B 2027/0181

(57) ABSTRACT

The invention relates to a display device comprising:
a support having a partially reflective portion referred to as useful portion;
a screen capable of emitting a light beam; and
a mechanism for adjusting the position and/or orientation of the screen according to the relevant driver profile such that:
in head-up display mode, the light beam emitted by the screen is reflected off the useful portion to form a virtual image in the field of view of the relevant driver profile, and
in direct display mode, the items of information emitted by the screen are directly readable on the screen by the relevant driver profile.

### TECHNICAL FIELD OF THE INVENTION

The present invention relates to a head-up display device for a vehicle. The present invention further relates to an associated vehicle.

### BACKGROUND OF THE INVENTION

Vehicles, in particular motor vehicles, are equipped with control panels, also called an instrument cluster or dashboard, to show the driver information useful for driving and operating the vehicle. For this purpose, the control panel comprises the on-board instruments of the vehicle, some of which are required by the legislation.

For a motor vehicle, the control panel is conventionally integrated into the dashboard of the vehicle under the windscreen, behind the steering wheel. Typically, such a control panel is arranged at least at −15° from the direction of sight of an average driver looking at the road, about 50 centimeters from the eyes. The driver is then led to take his/her eyes off the road to view the control panel, which reduces alertness and increases eye fatigue through the constantly required visual accommodation effort.

In order to allow useful information to be displayed more safely, it is known to use head-up displays that transmit to the driver a few items of information coming from the control panel.

Nevertheless, such displays occupy an additional space in the vehicle, in redundancy of the control panel, and are in some cases very bulky. Furthermore, in certain situations, in particular in case of high brightness, the items of information emitted by the head-up display are sometimes less contrasted, which can be detrimental to driving safety.

### SUMMARY OF THE INVENTION

There is thus a need for an ergonomic device making it easier for the driver to visualize information useful for controlling the vehicle so as to improve driving, safety and maintaining the vigilance of the driver.

For this purpose, the present description relates to a head-up display device for a vehicle, the display device comprising a head-up display mode and a direct display mode, each mode being adjustable for different driver profiles, the display device comprising:
a support apt for being positioned opposite the upper part of the body of a driver in the driving position, at least a portion of the support, called the useful portion, being partially reflective,
a unit for transmitting control information of the vehicle, the unit for transmitting information comprising a screen apt to emit at least one light beam, and
a mechanism for adjusting the position and/or orientation of the screen according to the relevant driver profile and so that:
in the head-up display mode, the light beam emitted by the screen is reflected off the useful portion of the support so as to form a virtual image in the field of view of the relevant driver profile in the driving position, and
in direct display mode, the items of information emitted by the screen are directly readable on the screen by the relevant driver profile.

According to other advantageous aspects, the display device comprises one or a plurality of the following features, taken individually or according to all technically possible combinations:
the device comprises at least one element, called HUD element, apt to mask the direct view of the screen in the head-up display mode;
the or at least one HUD element is:
   the adjustment mechanism, the adjustment mechanism being apt to adjust the position and/or orientation of the screen so as to mask the direct view of the screen by the relevant driver profile in the head-up display mode, and/or
   the screen, the screen having an angle of view of less than or equal to 45 degrees in the head-up display mode so as to limit the direct view of the screen, and/or
   a shutter, called a screen shutter, the screen shutter being apt, in the head-up display mode, for masking the direct view of the screen for the relevant driver profile, without masking the direct view of the screen by the relevant driver profile in the direct display mode;
the screen has an emitting surface comprised in a plane, called the screen plane, when the or at least one HUD element is the adjustment mechanism, the adjustment mechanism being apt to adjust the position and/or orientation of the screen in the head-up display mode so that the angle oriented between, the screen plane, and the normal to the useful portion passing through the center of the screen, called the HUD angle, is less than or equal to an angle, called the HUD limit angle, the HUD limit angle being the angle from which the screen is not visible for the relevant driver profile while permitting the formation of a virtual image in the field of view of the driver profile by reflection of the beam emitted by the screen on the useful portion of the support.
the device comprises at least one element, called a direct element, apt to prevent, in the direct display mode, the generation of a spurious virtual image resulting from the reflection of the beam emitted by the screen on the useful portion of the support;
the or at least one direct element is:
   the adjustment mechanism, the adjustment mechanism being apt for adjusting the position and/or orientation of the screen so as to prevent, in the direct display mode, the generation of a spurious virtual image resulting from the reflection of the beam emitted by the screen on the useful portion of the support,
   the screen, the screen having an angle of view less than or equal to 45 degrees in the direct display mode so as to limit the generation of a spurious virtual image by reflection of the beam coming from the screen on the useful portion of the support, and/or
   a shutter, called a support shutter, the support shutter being apt for preventing, in the direct display mode, the reflection of the beam from the screen onto the support, without obstructing said reflection in the head-up display mode;
the screen has an emitting surface comprised in a plane, called the screen plane, when the or at least one direct element is the adjustment mechanism, the adjustment mechanism being apt to adjust the position and/or orientation of the screen in the direct display mode so that the angle oriented between, the normal to the useful portion passing through the center of the screen, and the screen plane, called the direct angle, is less than or equal to a limit direct angle, the limit direct angle being the angle from which the beam coming from the screen is no longer reflected on the useful portion of the support while permitting the direct view of the screen;
the emission unit comprises at least one optical element along the path of the light beam emitted by the screen in the head-up display mode and/or in the direct display mode, so as to modify the properties of the image visible by the relevant driver profile;
the useful portion has a non-zero curvature so as to form a concave mirror on the driver's side, the adjustment mechanism comprising at least one pivot element apt to pivot the screen, the pivot point of the pivot element being chosen so that in the head-up display mode, the screen is at a distance from the useful portion comprised between a minimum distance and a maximum distance, the maximum distance being chosen depending on the radius of curvature of the concave mirror so that the virtual image formed is the same image for the right eye and the left eye of the relevant driver profile.

The present description further relates to a vehicle comprising a display device such as described hereinabove.

### BRIEF DESCRIPTION OF THE DRAWINGS

Other features and advantages of the invention will appear upon reading the following description which follows embodiments of the invention, given only as a limiting example, and making reference to the following drawings:

FIG. 1, a schematic representation of an example of a head-up display device having a head-up display mode and a direct display mode,

FIG. 2, a schematic representation of an example of an adjustment made by the adjustment mechanism to mask the direct view of the screen in the head-up display mode,

FIG. 3, a schematic representation of another example of adjustment by the adjustment mechanism to mask the direct view of the screen in the head-up display mode, depending on the relevant driver profile,

FIG. 4, a schematic representation of an example of an adjustment made by the adjustment mechanism to prevent the generation of a spurious virtual image in the direct display mode,

FIG. 5, a schematic representation of an example of the selection of a restricted angle of view for the screen to limit direct view of the screen in the head-up display mode,

FIG. 6, a schematic representation of an example of a screen shutter apt for masking the direct view of the screen in the head-up display mode for the relevant driver profile,

FIG. 7, a schematic representation of an example of the choice of the height of a screen shutter so as to mask the direct view of the screen for a driver profile considered in the head-up display mode, without masking the direct view of the screen in the direct display mode,

FIG. 8, a schematic representation of an example of a support shutter apt to prevent, in the direct display mode, the reflection of the beam coming from the screen onto the support, and

FIG. 9, a schematic representation of an example of the choice of the height of a support shutter so as to prevent the reflection of the beam coming from the screen onto the support in the direct display mode, without obstructing said reflection in the head-up display mode.

### DETAILED DESCRIPTION OF SOME EMBODIMENTS

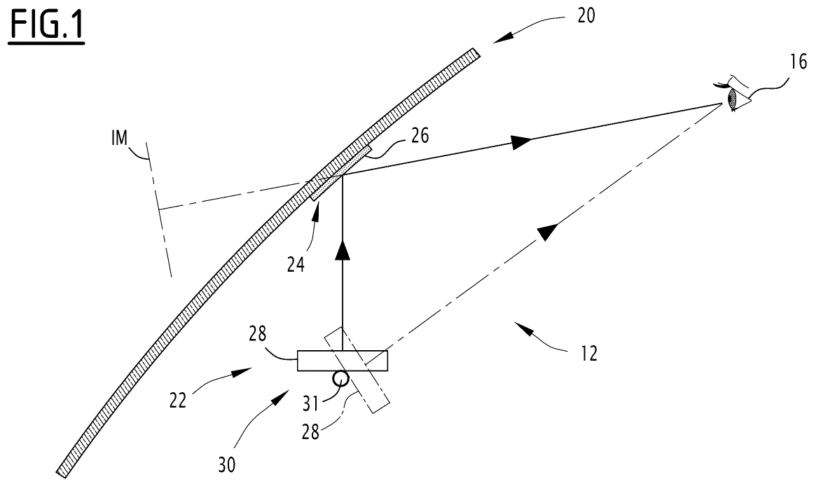

A head-up display device 12 is illustrated by FIG. 1.

The display device 12 is apt for being integrated into a vehicle. The vehicle is e.g. a land, an aerial or a naval vehicle. The land vehicle is e.g. a motor vehicle, a railway vehicle, a two-wheeled vehicle (whether or not motorized) or a three-wheeled vehicle (whether or not motorized).

The display device 12 is apt for displaying control information of a vehicle to a driver 16 when the vehicle is being driven by the driver 16. Such control information is, e.g., information coming from the on-board instruments of the vehicle, navigation information, safety information or communication information coming from an on-board system of the vehicle or from an electronic device of the driver, such as a smartphone.

As an example, the information relates to a speed indicator of the vehicle, to the energy consumption of the vehicle, to alarms relating to the malfunction of certain components of the vehicle or to navigation information (mapping, positions, directions).

The display device 12 has two distinct display modes, namely a head-up display mode and a direct display mode. In the head-up display mode, the display device 12 is apt for forming a virtual image IM in the field of view of the driver 16 in the driving position. In the direct display mode, the display device 12 is apt for displaying the driving information on a screen directly visible to the driver 16. The display modes are discussed in detail thereafter in the description.

Each display mode is adjustable (configurable) according to different conductor profiles 16, i.e. the position and/or orientation of each mode is adjustable according to the conductor profiles. A driver profile is a body template in a driving posture in the vehicle. For example, each display mode is adjustable to cover driver profiles ranging from the fifth percentile of the female population (small female) to the ninety-fifth percentile of the male population (tall male).

Preferably, the display device 12 has the function of the dashboard of the vehicle wherein same is integrated. Thereby in such case, the on-board instruments of the vehicle are only displayed on the display device 12. The dashboard of the vehicle is thereby devoid of mechanical dashboard instruments integrated into the dashboard and digital dashboard instruments integrated into the dashboard, which are different from the display device 12. In such case, the display device 12 is configured to be switched on automatically when the ignition is switched on in the vehicle and to be switched off automatically when the ignition is switched off in the vehicle.

As illustrated in FIG. 1, the display device 12 comprises a support 20, a unit 22 for transmitting control information of the vehicle, and an adjustment mechanism 30. Preferentially, the display device 12 further comprises at least one element, called the HUD element 36 and/or at least one element, called the direct element 38, the functions of which will be discussed in detail thereafter in the description.

The support 20 is apt for being positioned facing the upper part of the body (at least part of the torso) of the driver 16 in the driving position.

The support 20 is e.g. transparent or partially transparent.

The body 20 is e.g. made of polycarbonate.

The support 20 has at least one portion, called the useful portion 24, which is partially reflective.

In an example of embodiment, as illustrated by FIG. 1, the useful portion 24 is covered with a reflector element 26 imparting the partially reflective function. The reflector element 26 is e.g. a coating or treatment (e.g. obtained by physical deposition or chemical deposition) or a film (e.g. laminated or held by electrostatic effect).

In a variant, the reflector element 26 is inside the useful portion 24.

In the example of FIG. 1, the useful portion 24 extends over only a portion of the support 20, in the present case a portion making it possible to generate a virtual image IM in the field of view (direct or peripheral) of the driver 16 in the driving position, as will be explained hereinafter. In a variant, the useful portion 24 extends over the entire support 20. In the example shown in FIG. 1, the useful portion 24 is substantially flat. In a variant, the useful portion 24 has a non-zero curvature so as to form a concave mirror on the driver's side.

Preferably, the support 20 is an element apt for deflecting the air when the vehicle is being driven. The support 20 thereby has the function of a windscreen and is called as such. Same is also called a deflector or bubble, in particular in the case of two-wheel vehicles. In a variant, the support 20 is a blade also called a “combiner”.

The emission unit 22 is apt for displaying control information of the vehicles. The information preferably comprises information provided by on-board instruments of the vehicle or else navigation information, safety information or communication information coming from an on-board system of the vehicle or from an electronic device of the driver, such as a smartphone. To this end, the emission unit 22 is apt for emitting at least one light beam.

The transmission unit 22 comprises at least one screen 28. The screen 28 has an emitting surface comprised in a plane, called the screen plane PE.

Preferably, the emission unit 22 comprises at least one optical element along the path of the light beam emitted by the screen 28 in the head-up display mode and/or in the direct display mode, so as to modify the properties (e.g. magnification) of the image visible by the relevant driver 16. The optical elements are e.g. lenses or mirrors. The optical elements are e.g. either attached or not attached to the screen 28. The optical elements are e.g. used in only one mode.

Preferably, the screen 28 is apt for displaying a real image from which the light beam coming from the emission unit 22 is emitted.

Preferably, the screen 28 is brighter in the head-up display mode than in the direct display mode. In a variant, the brightness of the screen 28 is the same for both modes, or is adaptable for each mode.

The screen 28 is e.g. a liquid crystal display (LCD) or an organic light emitting diode (OLED) screen.

The adjustment mechanism 30 is apt for adjusting the position and/or orientation of the screen 28 according to the relevant driver profile 16 such that:
In the head-up display mode, the light beam emitted by the screen 28 is reflected on the useful portion 24 of the support 20 to form a virtual image IM in the field of view of the relevant driver profile 16 in the driving position, and
in the direct display mode, the information emitted by the screen 28 can be read directly on the screen 28 by the relevant driver profile 16 (when the driver 16 in the driving position is looking at the screen 28).

The adjustment mechanism 30 comprises e.g. a pivot element 31 (as in FIG. 1) apt for pivoting the screen 28 between the head-up display mode and the direct display mode and, where appropriate, for adjusting the orientation of the screen 28 to the relevant driver profile 16. The pivot element 31 is e.g. a pivot, a ball joint, a curved slide or corresponds to a curvilinear guiding, or else a specific kinematics.

Preferably, the pivot point of the pivot element 31 is chosen so that, in the head-up display mode, the screen 28 is at a distance from the useful portion 24 comprised between a minimum distance and a maximum distance.

In particular, when the useful portion 24 of the support 20 has a non-zero curvature so as to form a concave mirror on the driver's side, the maximum distance is chosen as a function of the radius of curvature of the concave mirror so as to compensate for the optical disparities between the right eye and the left eye of the relevant driver profile 16. In other words, the maximum distance is chosen as a function of the radius of curvature of the concave mirror so that the virtual image IM formed is the same image for the right eye and the left eye of the relevant driver profile 16. For example, the maximum distance is given by the following formula:

dₘₐₓ=−A.R²+B.R+C

Where:
dₘₐₓ is the maximum distance,
R is the radius of curvature of the concave mirror, and
A, B and C are positive numbers.

The minimum distance is e.g. the minimum distance for allowing the beam coming from the screen 28 to be reflected on the useful portion 24 of the support 20.

Preferably, the pivot element 31 is apt for making the screen 28 pivot about a pivot axis so as to modify the orientation of the (real) image generated by the screen 28. The image is thereby inverted for the head-up display mode and not inverted for the direct display mode. For example, when the screen 28 is a screen 16/9 and the display on the screen 28 is a landscape display, the pivot axis is horizontal. When the screen 28 is a screen 16/9 and the display on the screen 28 is a portrait display, the pivot axis is vertical.

Preferably, the adjustment mechanism 30 further comprises a translation element apt for translating the screen 28 as a function of the relevant driver profile 16 and possibly also for translating the screen 28 between the head-up display mode and the direct display mode.

The or each HUD element 36 is apt for masking the direct view of the screen 28 in the head-up display mode. Disturbing the view of the driver 16 with information coming from the screen 28 other than the information coming from the reflection of the beam coming from the screen 28 on the support 20, is thereby prevented.

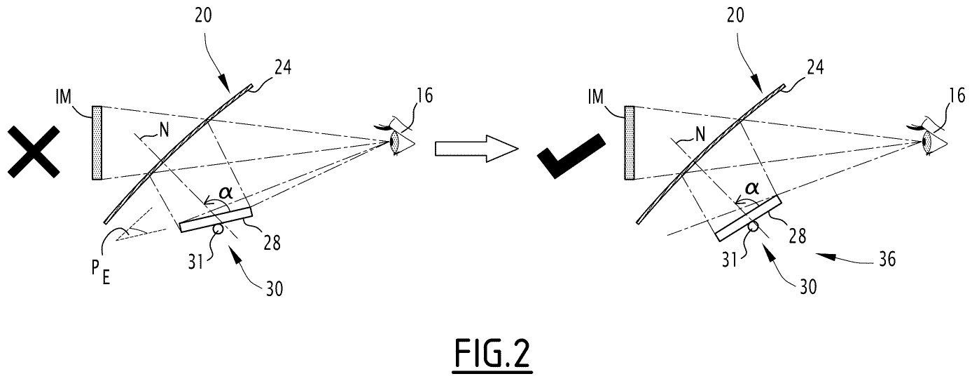

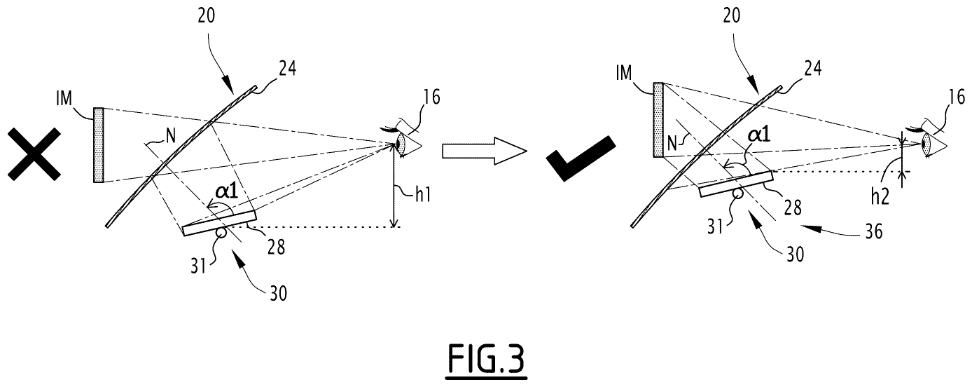

In an embodiment illustrated in FIGS. 2 and 3, the or at least one HUD element 36 is the adjustment mechanism 30. In such case, the adjustment mechanism 30 is apt for adjusting the position and/or orientation of the screen 28 so as to mask the direct view of the screen 28 by the relevant driver profile 16 in the head-up display mode.

In the example of embodiment illustrated in FIGS. 2 and 3, the adjustment mechanism 30 is apt for adjusting the position and/or orientation of the screen 28 in the head-up display mode so that the angle oriented between the screen plane P_{E} and the normal N to the useful portion 24 passing through the center of the screen 28, called the HUD angle α, is less than or equal to an angle, called the limit HUD angle α_{L}. The limit HUD angle α_{L} is the angle from which the screen 28 is not visible for the relevant conductor profile 16 while permitting the formation of a virtual image IM in the field of view of the conductor profile 16 by reflection of the beam emitted by the screen 28 on the useful portion 24 of the support 20.

Thereby, in the left-hand configuration of FIG. 2, the HUD angle α is greater than the limit HUD angle α_{L}, and the screen 28 remains visible in direct view, whereas in the right-hand configuration, the HUD angle α is less than or equal to the limit HUD angle α_{L}, and the screen 28 is masked in direct view. FIG. 3 illustrates the fact that the limit HUD angle α_{L} depends on the height h of the eyes of the relevant driver profile 16 with respect to the screen 28 (for the same HUD angle α₁, the direct view is visible for a profile at a height h₁, but is masked for a profile at a height h₂).

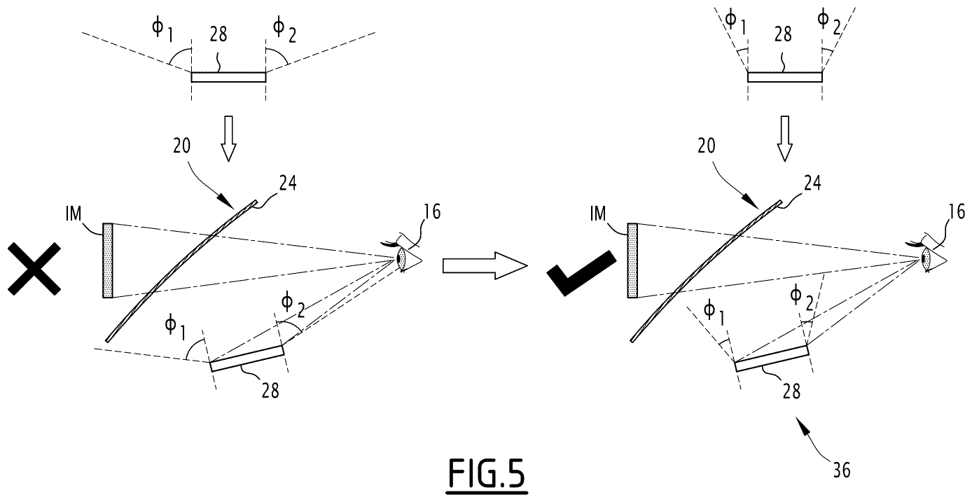

In another embodiment illustrated in FIG. 5, the or at least one HUD element 36 is the screen 28. In such case, the screen 28 has an angle of view less than or equal to 45 degrees in the head-up display mode so as to limit the direct view of the screen 28. The reduction of the angle of view of the screen 28 is obtained e.g. with different screen technologies (IPS, TN) or else by adding a privacy filter over the screen 28.

More particularly, the left-hand configuration of FIG. 5 illustrates a screen 28 with a larger angle of view than in the right-hand configuration. Consequently, for the same position and orientation of the screen 28, as well as the same driver profile 16, in the head-up display mode, the screen 28 remains visible in direct view for the left-hand configuration, whereas same is masked for the right-hand configuration. Used in addition to the previous example (FIGS. 2 and 3), thereof allows the requirements on the HUD angle α or on the height h of the eyes of the driver 16 to be relaxed.

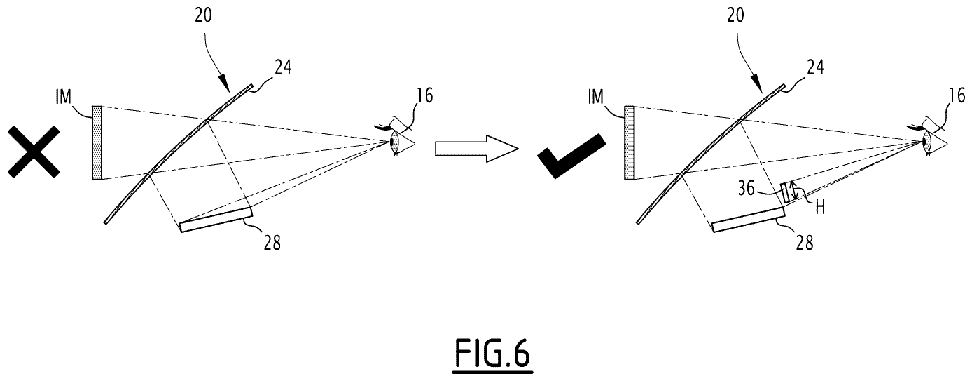

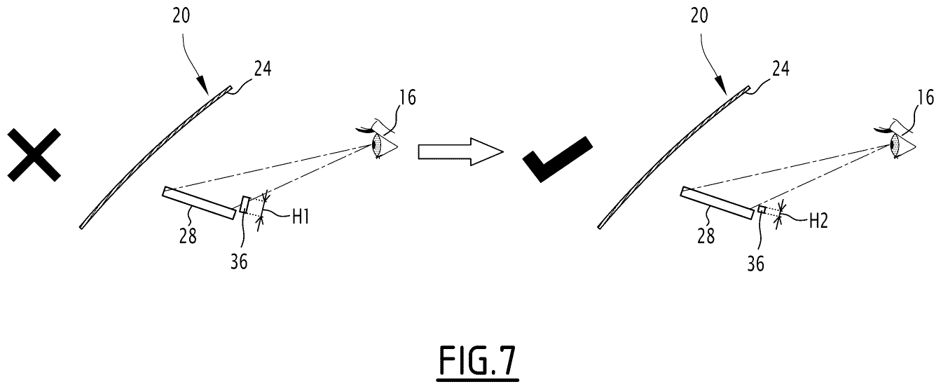

In yet another example of embodiment illustrated in FIGS. 6 and 7, the or at least one HUD element 36 is a shutter (mechanical privacy screen), called a screen shutter. The screen shutter is apt, in the head-up display mode, for masking the direct view of the screen 28 for the relevant driver profile 16, without masking the direct view of the screen 28 by the relevant driver profile 16 in the direct display mode.

Thereby, in the configuration on the right of FIG. 6 compared with the configuration on the left, the screen shutter is apt for masking the direct view of the screen 28. FIG. 7 illustrates the choice of the height of the screen shutter so as not to mask the direct view of the screen 28 in the direct display mode (for the same driver profile 16, the direct view is visible for a screen shutter of height H1 but is masked for a screen shutter of height H2). The adjustment can be done either by changing the height of the screen shutter or by changing the position thereof.

The person skilled in the art will understand that the different versions of HUD elements can be combined within the same display device 12 (adjustment mechanism 30 and/or angle of view of the screen 28 and/or shutter screen).

The or each direct element 38 is apt for preventing, in the direct display mode, the generation of a spurious virtual image resulting from the reflection of the beam emitted by the screen 28 on the useful portion 24 of the support 20. Disturbing the view of the driver 16 with information other than the information coming from the direct view of the screen 28 in the direct display mode, is thereby prevented.

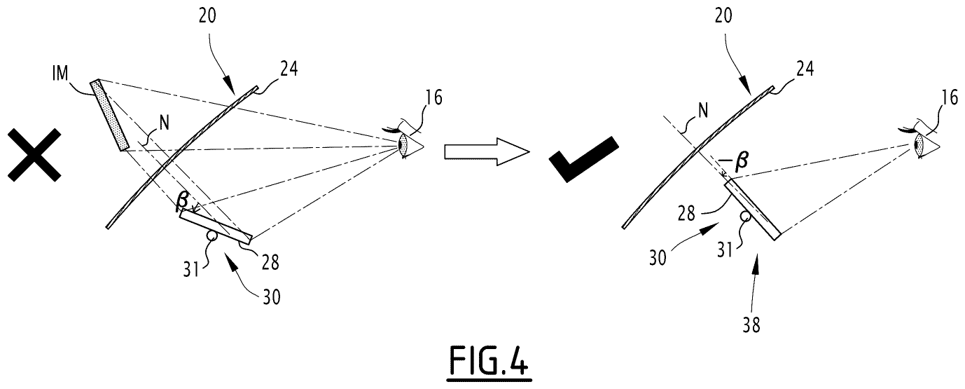

In an embodiment illustrated in FIG. 4, the or at least one direct element 38 is the adjustment mechanism 30. In such case, the adjustment mechanism 30 is apt for adjusting the position and/or orientation of the screen 28 so as to prevent, in the direct display mode, the generation of a spurious virtual image resulting from the reflection of the beam emitted by the screen 28 on the useful portion 24 of the support 20.

In the example of embodiment illustrated in FIG. 4, the adjustment mechanism 30 is apt to adjust the position and/or orientation of the screen 28 in the head-up display mode so that the angle oriented between the normal N to the useful portion 24 passing through the center of the screen 28 and the screen plane P_{E}, called the direct angle β, is less than or equal to a limit direct angle β_{L}. The limit direct angle β_{L} (which may be negative) is the angle from which the beam coming from the screen 28 is no longer reflected on the useful portion 24 of the support 20 while allowing a direct view of the screen 28.

Thereby, in the left-hand configuration of FIG. 4, the direct angle β is greater than the direct limit angle, and a spurious virtual image resulting from the reflection of the beam coming from the screen 28 on the useful portion 24 of the support 20, is generated. On the other hand, in the right-hand configuration of FIG. 4, the direct angle β is less than or equal to the direct limit angle, and the spurious virtual image is not generated.

In another example of implementation, the or at least one direct element 38 is the screen 28. In such case, the screen 28 has an angle of view less than or equal to 45 degrees in the direct display mode so as to limit the reflection of the beam coming from the screen 28 on the useful portion 24 of the support 20.

The reduction of the angle of view of the screen 28 is obtained e.g. with different screen technologies (IPS, TN) or else by adding a privacy filter over the screen 28.

Used in addition to the previous example (FIG. 4), thereof allows the requirements on the direct angle β or on the height h of the eyes of the driver 16, to be relaxed.

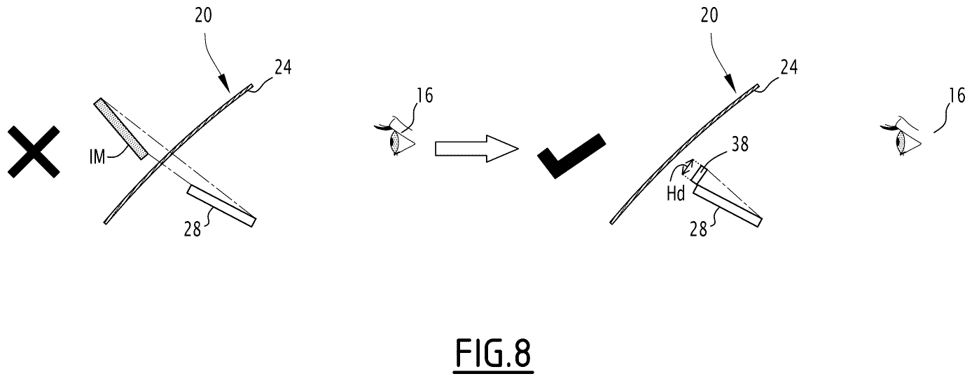

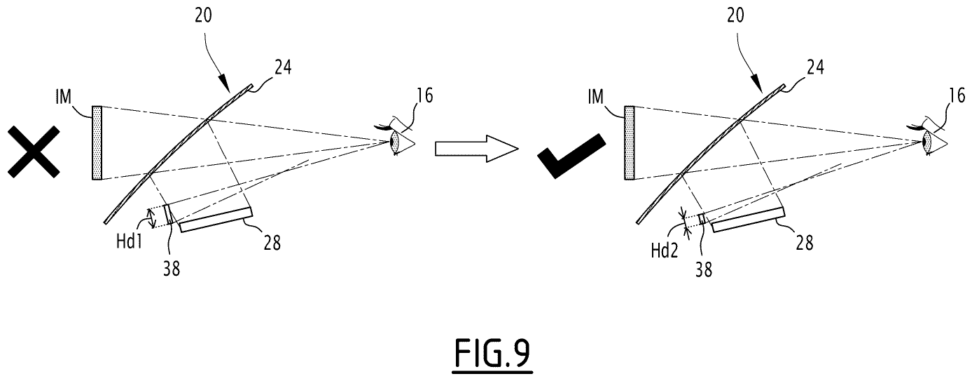

In yet another example of embodiment illustrated in FIGS. 8 and 9, the or at least one direct element 38 is a shutter (mechanical privacy screen), called a support shutter. The support shutter is apt for preventing, in the direct display mode, the reflection of the beam coming from the screen 28 onto the support 20, without obstructing said reflection in the head-up display mode.

Thereby, in the configuration on the right of FIG. 8 compared with the configuration on the left, the support shutter is apt for preventing the reflection of the beam coming from the screen 28 onto the support 20. FIG. 9 illustrates the choice of the height of the support shutter so as not to obstruct the reflection of the beam coming from the screen 28 on the support 20 in the head-up display mode (for the same conductor profile 16, the reflection is obstructed for a support shutter of height Hd1 and is completely unobstructed for a support shutter of height Hd2). The adjustment can be made either by modifying the height of the support shutter or by modifying the position thereof.

A person skilled in the art will understand that the different versions of direct elements can be combined within the same display device 12 (adjustment mechanism 30 and/or angle of view of the screen 28 and/or shutter support).

The operation of the display device 12 will now be described.

In the head-up display mode, the position and/or orientation of the screen 28 of the display device 12 is adjusted by the adjustment mechanism 30 according to the relevant driver profile 16 so that the light beam emitted by the screen 28 is reflected on the useful portion 24 of the support 20 to form a virtual image IM in the field of view of the relevant driver profile 16. Where appropriate, the HUD element(s) make it possible to mask the direct view of the screen 28.

In the direct display mode, the position and/or the orientation of the screen 28 of the display device 12 is adjusted by the adjustment mechanism 30 according to the relevant driver profile 16 so that the information emitted by the screen 28 can be read directly on the screen 28 by the relevant driver profile 16. Where appropriate, the direct element or elements prevent the generation of a spurious virtual image resulting from the reflection of the beam emitted by the screen 28 on the useful portion 24 of the support 20.

Thereby, due to the two display modes thereof, the display device 12 is an ergonomic and compact device, easily integrated into a vehicle. Such a device 12 facilitates the safe view by the driver 16 of information useful for driving, whatever the ambient conditions, since it is easy to switch from one mode to another.

In the embodiments comprising HUD elements and/or direct elements, the spurious images (resulting from parasitic reflections in the direct display mode and from the direct view of the screen 28 in the head-up display mode) are further reduced in order to further improve the view of useful information and to make safe driving possible.

Such a display device 12 is further apt for being integrated into a vehicle to replace the instrument panel. However, same can also be used in addition to the instrument panel.

A person skilled in the art would understand that the embodiments described hereinabove are likely to be combined with one another when such combinations are compatible.

1. A head-up display device for a vehicle, the display device comprising a head-up display mode and a direct display mode, each mode being adjustable for different driver profiles, the display device comprising:
a support apt for being positioned opposite the upper part of the body of a driver in the driving position, at least a portion of the support, called the useful portion, being partially reflective,
a unit for transmitting vehicle control information, the transmission unit comprising a screen apt for emitting at least one light beam, and
a mechanism for adjusting the position and/or orientation of the screen according to the relevant driver profile and such that:
In the head-up display mode, the light beam emitted by the screen is reflected on the useful portion of the support to form a virtual image in the field of view of the relevant driver profile in the driving position, and
in direct display mode, the items of information emitted by the screen are directly readable on the screen by the relevant driver profile.

2. The device according to claim 1, wherein the device comprises at least one element, called the HUD element apt to mask the direct view of the screen in the head-up display mode.

3. The device according to claim 2, wherein the or at least one HUD element is:
a. the adjustment mechanism, the adjustment mechanism being apt to adjust the position and/or orientation of the screen so as to mask the direct view of the screen by the relevant driver profile in the head-up display mode, and/or
b. the screen, the screen having an angle of view of less than or equal to 45 degrees in the head-up display mode so as to limit the direct view of the screen, and/or
c. a shutter, called a screen shutter, the screen shutter being apt, in the head-up display mode, for masking the direct view of the screen for the relevant driver profile, without masking the direct view of the screen by the relevant driver profile in the direct display.

4. The device according to claim 3, wherein the screen has an emitting surface comprised in a plane, called the screen plane, when the or at least one HUD element is the adjustment mechanism, the adjustment mechanism being apt for adjusting the position and/or orientation of the screen in the head-up display mode so that the angle oriented between, the screen plane, and the normal to the useful portion passing through the center of the screen called the HUD angle is less than or equal to an angle, called the limit HUD angle, the limit HUD angle being the angle from which the screen is not visible for the relevant driver profile while permitting the formation of a virtual image in the field of view of the driver profile by reflection of the beam emitted by the screen on the useful portion of the support.

5. The device according to claim 1, wherein the device comprises at least one element, called a direct element, apt for preventing, in the direct display mode, the generation of a spurious virtual image resulting from the reflection of the beam emitted by the screen on the useful portion of the support.

6. The device according to claim 5, wherein the or at least one direct element is:
a. the adjustment mechanism, the adjustment mechanism being apt for adjusting the position and/or orientation of the screen so as to prevent, in the direct display mode, the generation of a spurious virtual image resulting from the reflection of the beam emitted by the screen on the useful portion of the support,
b. the screen, the screen having an angle of view less than or equal to 45 degrees in the direct display mode so as to limit the generation of a spurious virtual image by reflection of the beam coming from the screen onto the useful portion of the support, and/or
c. a shutter, called a support shutter, the support shutter being apt for preventing, in the direct display mode, the reflection of the beam from the screen onto the support, without obstructing said reflection in the head-up display.

7. The device according to claim 1, wherein the screen has an emitting surface comprised in a plane, called the screen plane when the or at least one direct element is the adjustment mechanism, the adjustment mechanism being apt for adjusting the position and/or orientation of the screen in the direct display mode so that the angle oriented between, the normal to the useful portion passing through the center of the screen, and the screen plane, called the direct angle is less than or equal to a limit direct angle, the limit direct angle being the angle from which the beam coming from the screen is no longer reflected onto the useful portion of the support while permitting the direct view of the screen.

8. The device according to claim 1, wherein the emission unit comprises at least one optical element along the path of the light beam emitted by the screen in the head-up display mode and/or in the direct display mode, so as to modify the properties of the image visible by the relevant driver

9. The device according to claim 1, wherein the useful portion as a non-zero curvature so as to form a concave mirror on the driver's side, the adjustment mechanism comprising at least one pivot element apt to pivot the screen, the pivot point of the pivot element being chosen so that in the head-up display mode the screen is at a distance from the useful portion comprised between a minimum distance and a maximum distance, the maximum distance being chosen depending on the radius of curvature of the concave mirror so that the virtual image formed is the same image for the right eye and the left eye of the relevant driver profile.

10. A vehicle comprising a display device according to claim 1.
